(19) United States
(12) Patent Application Publication
(10) Pub. No.: US 2022/0403594 A1
(43) Pub. Date: Dec. 22, 2022

(54) PRINT METHOD AND PRINT DEVICE

(71) Applicants: Tomohiro HIRADE, Kanagawa (JP); Makoto KURONUMA, Kanagawa (JP)

(72) Inventors: Tomohiro HIRADE, Kanagawa (JP); Makoto KURONUMA, Kanagawa (JP)

(21) Appl. No.: 17/841,682

(22) Filed: Jun. 16, 2022

(30) Foreign Application Priority Data
Jun. 22, 2021 (JP) 2021-103420

(51) Int. Cl. D06P 5/30; D06P 5/00; D06P 1/52; C09D 11/322; C09D 11/36; C09D 11/54; C09D 11/102; C09D 11/033; B41M 5/00; B41J 3/407

(52) U.S. Cl. CPC D06P 5/30; D06P 5/002; D06P 1/5292; D06P 1/5285; C09D 11/322; C09D 11/36; C09D 11/54; C09D 11/102; C09D 11/033; B41M 5/0011; B41J 3/4078

(57) ABSTRACT

A print method includes applying a first processing fluid comprising water and a lubricant to a fabric, applying a second processing fluid comprising water and a flocculant to the fabric, and applying an ink to the region of the fabric where the first processing fluid and the second processing fluid have been applied.

### CROSS-REFERENCE TO RELATED APPLICATIONS

This patent application is based on and claims priority pursuant to 35 U.S.C. § 119 to Japanese Patent Application No. 2021-103420, filed on Jun. 22, 2021, in the Japan Patent Office, the entire disclosure of which is hereby incorporated by reference herein.

### BACKGROUND

### Technical Field

The present disclosure relates to a print method and a print device.

### Description of the Related Art

Since inkjet printers are capable of readily and quietly printing color images with low running costs, they are now widely used at home to output digital information.

In recent years, such inkjet technologies have been appealing in business fields of, for example, display, posters, and signboards in addition to home use.

The market of direct printing on fabrics including T-shirts, so called direct to garment (DTG), is expanding year by year in the dyeing business. On the rise of personal recommendation business in apparel business and the trend of the active collaboration with fine art appearing in the interior textile field, there is demand for inkjet printing capable of printing images with excellent coloring and fastness on fabrics.

Unlike screen printing and other common printings, inkjet printing for directly forming an image on a fabric with ink containing a pigment obviates the need for manufacturing, storing, and rinsing a color plate. Moreover, inkjet printing is suitable for high-mix low-volume manufacturing, quickens delivery by dispensing with transfer, and demonstrates excellent light resistance. Enhancing the coloring and fastness of printed matter has been tried for pigment dyeing. However, it is challenging to improve these properties by developing ink alone, so pre-processing fabric before printing ink on the material has been proposed.

### SUMMARY

According to embodiments of the present disclosure, a print method is provided which includes applying a first processing fluid comprising water and a lubricant to a fabric, applying a second processing fluid comprising water and a flocculant to the fabric, and applying an ink to the region of the fabric where the first processing fluid and the second processing fluid have been applied.

As another aspect of embodiments of the present disclosure, a print device is provided which includes a first container containing a first processing fluid comprising water and a lubricant, a second container containing a second processing fluid comprising water and a flocculant, an ink container containing an ink, a first applying device for applying the first processing fluid to a fabric, a second applying device for applying the second processing fluid to the fabric, and an ink applying device for applying the ink to a region of the fabric where the first processing fluid and the second processing fluid have been applied.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating an example of a print device; and

FIG. 2 is a schematic diagram illustrating an example of a container.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

The terms of image forming, recording, and printing in the present disclosure represent the same meaning.

Also, recording media, media, and print substrates in the present disclosure have the same meaning unless otherwise specified.

According to the present disclosure, a print method is provided which enhances the storage stability of processing fluid applied to a fabric before applying the ink to the fabric and the flexibility of printed matter formed by using the processing fluid and ink.

Next, one embodiment of the present disclosure is described.

Print Method

The print method of the present disclosure includes applying a first processing fluid containing water and a lubricant to a fabric, applying a second processing fluid containing water and an flocculant to the fabric, and applying ink to the region of the fabric where the first processing fluid and the second processing fluid have been applied. The print method of the present disclosure may furthermore optionally contain other processes.

The first processing fluid and the second processing fluid in the present disclosure mean individual liquid compositions applied to the fabric before using the ink.

The ink in the present disclosure is a liquid composition for forming a color image by applying it to the region of the fabric where the first processing fluid and the second processing fluid have been applied.

Application of First Processing Fluid

Application of the first processing fluid, hereinafter also referred to as the first application, is to apply the first processing fluid to a fabric.

The first application is not particularly limited and can be suitably selected to suit a particular application. It includes inkjetting, blade coating, gravure coating, bar coating, roll coating, dip coating, curtain coating, slide coating, die coating, and spray coating. Of these, inkjetting the fluid to a fabric is preferable. Since the first processing fluid for use in the print method of the present disclosure is stable about the viscosity as described later, meaning having good storage stability, the fluid is suitable for inkjetting, whose discharging ability is strongly dependent on the density.

First Processing Fluid

The first processing fluid contains a lubricant and water. The first processing fluid may optionally furthermore contain an organic solvent, a surfactant, and other components.

Lubricant

A lubricant enhances the fastness and flexibility of printed matter when it contains the lubricant. A first processing fluid containing a lubricant enhances the fastness and flexibility of printed matter when applied to form the matter.

The lubricant is preferably an anionic or nonionic compound to minimize contamination inside a device attributable to mist produced when applying the first processing fluid to a fabric. Since the mist increases when discharging the first processing fluid by inkjetting, an anionic or nonionic compound is preferable to reduce its production.

Specific examples of lubricants include, but are not limited to, siloxane compounds and wax. Siloxane compounds are preferable to enhance the fastness and flexibility of printed matter furthermore.

The siloxane compound is not particularly limited and can be suitably used to suit a particular application.

Specific examples include, but are not limited to, organopolysiloxane such as dimethyl polysiloxane and modified organopolysiloxane such as polyether-modified organopolysiloxane, amino-modified organopolysiloxane, hydroxy-modified organopolysiloxane, epoxy-modified organopolysiloxane, and phenyl-modified organopolysiloxane. Of these, dimethyl polysiloxane or amino-modified organopolysiloxane is preferable to enhance the dry rubbing fastness and flexibility of printed matter. These can be used alone or in combination.

Specific examples of the siloxane compounds include, but are not limited to, KM-860A, dimethyl polysiloxane, manufactured by Shin-Etsu Chemical Co., Ltd., KM-9737A, dimethyl polysiloxane, manufactured by Shin-Etsu Chemical Co., Ltd., KM-9782, dimethyl polysiloxane, manufactured by Shin-Etsu Chemical Co., Ltd., KM-862T, dimethyl polysiloxane, manufactured by Shin-Etsu Chemical Co., Ltd., KM-9738A, dimethyl polysiloxane, manufactured by Shin-Etsu Chemical Co., Ltd., POLON-MF-14, amino-modified organopolysiloxane, manufactured by Shin-Etsu Chemical Co., Ltd., POLON-MF-51, amino-modified organopolysiloxane, manufactured by Shin-Etsu Chemical Co., Ltd., X-51-1264, epoxy-modified organopolysiloxane, manufactured by Shin-Etsu Chemical Co., Ltd., KM-9739, phenyl-modified organopolysiloxane, manufactured by Shin-Etsu Chemical Co., Ltd., BYK-307, polyether-modified organopolysiloxane, manufactured by BYK-Chemie Japan, BYK-333, dimethyl polysiloxane, manufactured by BYK-Chemie Japan, and BYK-378, dimethyl polysiloxane, manufactured by BYK-Chemie Japan.

Wax is not particularly limited and can be suitably selected to suit a particular application. Polyethylene wax and carnauba wax are preferable to enhance the fastness and flexibility of printed matter. These can be used alone or in combination.

Polyethylene wax can be procured.

Specific examples include, but are not limited to, “Nopcoat” series, manufactured by SAN NOPCO LIMITED, “Nopcomal” series, manufactured by SAN NOPCO LIMITED, “Hitech” series, manufactured by TOHO Chemical Industry Company, Limited, and AQUACER series including AQUACER-515, manufactured by BYK Japan KK.

Carnauba wax can be procured.

Specific examples include, but are not limited to, Selosol 524 and Trasol CN, both manufactured by CHUKYO YUSHI CO., LTD.

The melting point of the wax is preferably from 50 to 130 degrees C. and more preferably from 60 to 120 degrees C. A melting point in the range specified above enhances the fastness and flexibility of printed matter.

It is preferable that the first processing fluid contain a lubricant in the form of particle, in other words, the lubricant be dispersed in the fluid. If the particle form is stably maintained in the first processing fluid, the fluid's viscosity is maintained, thereby enhancing the storage stability. Since the viscosity does not change, discharging the first processing fluid by inkjetting becomes suitable. Lubricants constituting particles can be liquid or solid.

The volume average particle diameter of lubricants is not particularly limited and can be suitably selected to suit a particular application. It is preferably 0.01 μm or greater and more preferably from 0.01 to 0.2 μm.

A volume average particle diameter of 0.01 μm or greater enhances the flexibility of printed matter. The volume average particle diameter can be measured by using an instrument such as a particle size analyzer. Nanotrac Wave-UT151, manufactured by MicrotracBEL Corp.

The proportion of the lubricant to the first processing fluid is preferably from 0.1 to 10.0 percent by mass and more preferably from 0.1 to 6.0 percent by mass. A proportion of 0.1 percent by mass or more further enhances the flexibility of printed matter. A proportion of 10.0 percent by mass or less enhances the washing fastness of printed matter.

Water

As the water, pure water and hyper pure water such as deionized water, ultrafiltered water, reverse osmosis water, and distilled water can be used.

The proportion of water in the first processing fluid is not particularly limited and can be suitably selected to suit a particular application. In terms of the drying property and discharging reliability of the first processing fluid, the proportion is preferably from 10.0 to 90.0 percent by mass, more preferably from 30.0 to 90.0 percent by mass and furthermore preferably from 50.0 to 90.0 percent by mass.

Organic Solvent

The organic solvent mentioned above is not particularly limited and water-soluble organic solvents can be used. Examples of the water-soluble organic solvent are polyols, ethers such as polyol alkylethers and polyol arylethers, nitrogen-containing heterocyclic compounds, amides, amines, and sulfur-containing compounds.

Specific examples of the water-soluble organic solvent include, but are not limited to: polyhydric alcohols such as ethylene glycol, diethylene glycol, 1,2-propanediol, 1,3-propanediol, 1,2-butanediol, 1,3-butanediol, 1,4-butanediol, 2,3-butanediol, 3-methyl-1,3-butane diol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butane triol, 1,2,3-butanetriol, 2,2,4-trimethyl-1,3-pentanediol, and petriol; polyol alkyl ethers such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether; polyol aryl ethers such as ethylene glycol monophenyl ether and ethylene glycol monobenzyl ether; nitrogen-containing heterocyclic compounds such as 2-pyrrolidone, N-methyl-2-pyrrolidone, N-hydroxyethyl-2-pyrrolidone, 1,3-dimethyl-2-imidazolidinone, ε-caprolactam, and γ-butyrolactone; amides such as formamide, N-methylformamide, N,N-dimethylformamide, 3-methoxy-N,N-dimethyl propioneamide, and 3-buthoxy-N,N-dimethyl propioneamide; amines such as monoethanolamine, diethanolamine, and triethylamine; sulfur-containing compounds such as dimethyl sulfoxide, sulfolane, and thiodiethanol; propylene carbonate, and ethylene carbonate.

Polyol compounds having eight or more carbon atoms and glycol ether compounds are also suitable as the organic solvents.

Specific examples of the polyol compounds having eight or more carbon atoms include, but are not limited to, 2-ethyl-1,3-hexanediol and 2,2,4-trimethyl-1,3-pentanediol.

Specific examples of the glycolether compounds include, but are not limited to, polyhydric alcohol alkylethers such as ethylene glycol monoethylether, ethylene glycol monobutylether, diethylene glycol monomethylether, diethylene glycol monoethylether, diethylene glycol monobutylether, tetraethylene glycol monomethylether, and propylene glycol monoethylether and polyhydric alcohol arylethers such as ethylene glycol monophenylether and ethylene glycol monobenzylether.

The proportion of organic solvents in the first processing fluid is not particularly limited and can be suitably selected to suit a particular application. It is preferably from 5.0 to 60.0 percent by mass and more preferably from 10.0 to 50.0 percent by mass to enhance the drying property and discharging reliability of the fluid.

Surfactant

It is possible to use silicone-based surfactants, fluorochemical surfactants, amphoteric surfactants, nonionic surfactants, and anionic surfactants can be used. To enhance the flexibility of printed matter, using silicone-based surfactants in combination with a lubricant is preferable. Unlike the lubricant, the surfactant is preferably dissolved in the first processing fluid.

The silicone-based surfactant has no specific limit and can be suitably selected to suit to a particular application.

The silicone-based surfactants not decomposed even in a high pH environment are preferable. The silicone-based surfactants include, for example, side chain-modified polydimethyl siloxane, both distal end-modified polydimethyl siloxane, one distal end-modified polydimethyl siloxane, and side chain both distal end-modified polydimethyl siloxane. As the modification group, it is particularly preferable to select a polyoxyethylene group or polyoxyethylene polyoxypropylene group because these demonstrate good properties as aqueous surfactants. The silicone-based surfactant includes a polyether-modified silicone-based surfactant. One of the surfactant is a compound in which a polyalkylene oxide structure is introduced into the side chain of the Si site of dimethyl silooxane.

Specific examples of the fluorochemical surfactant include, but are not limited to, perfluoroalkyl sulfonic acid compounds, perfluoroalkyl carboxylic acid compounds, ester compounds of perfluoroalkyl phosphoric acid, adducts of perfluoroalkyl ethylene oxide, and polyoxyalkylene ether polymer compounds having a perfluoroalkyl ether group in its side chain. These are particularly preferable because the fluorochemical surfactant does not readily produce foams.

Specific examples of the perfluoroalkyl sulfonic acid compounds include, but are not limited to, perfluoroalkyl sulfonic acid and salts of perfluoroalkyl sulfonic acid.

Specific examples of the perfluoroalkyl carbonic acid compounds include, but are not limited to, perfluoroalkyl carbonic acid and salts of perfluoroalkyl carbonic acid.

Specific examples of the polyoxyalkylene ether polymer compounds having a perfluoroalkyl ether group in its side chain include, but are not limited to, sulfuric acid ester salts of polyoxyalkylene ether polymer having a perfluoroalkyl ether group in its side chain, and salts of polyoxyalkylene ether polymers having a perfluoroalkyl ether group in its side chain.

Counter ions of salts in these fluorochemical surfactants are, for example, Li, Na, K. NH₄, NH₃CH₂CH₂OH, NH₂(CH₂CH₂OH)₂, and NH(CH₂CH₂OH)₃.

Specific examples of the amphoteric surfactants include, but are not limited to, lauryl aminopropionic acid salts, lauryl dimethyl betaine, stearyl dimethyl betaine, and lauryl dihydroxyethyl betaine.

Specific examples of the nonionic surfactants include, but are not limited to, polyoxyethylene alkyl phenyl ethers, polyoxyethylene alkyl esters, polyoxyethylene alkyl amines, polyoxyethylene alkyl amides, polyoxyethylene propylene block polymers, sorbitan aliphatic acid esters, polyoxyethylene sorbitan aliphatic acid esters, and adducts of acetylene alcohol with ethylene oxides.

Specific examples of the anionic surfactants include, but are not limited to, polyoxyethylene alkyl ether acetates, dodecyl benzene sulfonates, laurates, and polyoxyethylene alkyl ether sulfates.

The silicone-based surfactant has no particular limit and can be suitably selected to suit to a particular application. Specific examples include, but are not limited to, side-chain-modified polydimethyl siloxane, both end-modified polydimethyl siloxane, one-end-modified polydimethyl siloxane, and side-chain-both-end-modified polydimethyl siloxane. In particular, a polyether-modified silicone-based surfactant having a polyoxyethylene group or a polyoxyethylene polyoxypropylene group is particularly preferable because such a surfactant demonstrates good property as an aqueous surfactant.

Such surfactants can be synthesized or procured. Products can be procured from BYK-Chemie GmbH, Shin-Etsu Silicone Co., Ltd., Dow Corning Toray Co., Ltd., NIHON EMULSION Co., Ltd., Kyoeisha Chemical Co., Ltd., and others.

The polyether-modified silicon-based surfactant has no particular limit and can be suitably selected to suit to a particular application. For example, a compound is usable in which the polyalkylene oxide structure represented by the following Chemical Formula S-1 is introduced into the side chain of the Si site of dimethyl polysiloxane.

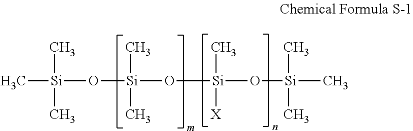

In Chemical Formula S-1, X=−R(C₂H₄O)ₐ(C₃H₆O)_{b}R′, “m”, “n”, “a”, and “b” each, respectively independently represent integers, R represents an alkylene group, and R′ represents an alkyl group.

Specific examples of the polyether-modified silicone-based surfactant include, but are not limited to, KF-618, KF-642, and KF-643 (all manufactured by Shin-Etsu Chemical Co., Ltd.), EMALEX-SS-5602 and SS-1906EX (both manufactured by NIHON EMULSION Co., Ltd.), FZ-2105, FZ-2118, FZ-2154, FZ-2161, FZ-2162, FZ-2163, and FZ-2164 (all manufactured by Dow Corning Toray Co., Ltd.). BYK-33 and BYK-387 (both manufactured by BYK Chemie GmbH), and TSF4440, TSF4452, and TSF4453 (all manufactured by Momentive Performance Materials Inc.).

As the fluorochemical surfactant, a compound in which the number of carbon atoms replaced with fluorine atoms is from 2 to 16 is preferable and, from 4 to 16, more preferable.

Specific examples of the fluorochemical surfactant include, but are not limited to, perfluoroalkyl phosphoric acid ester compounds, adducts of perfluoroalkyl with ethylene oxide, and polyoxyalkylene ether polymer compounds having a perfluoroalkyl ether group in its side chain.

Of these, polyoxyalkylene ether polymer compounds having a perfluoroalkyl ether group in its side chain are preferable because these do not readily foam and the fluorochemical surfactant represented by the following Chemical Formula F-1 or Chemical Formula F-2 is preferable.

CF₃CF₂(CF₂CF₂)ₘ—CH₂CH₂O(CH₂CH₂O)ₙH Chemical Formula F-1

In the compound represented by Chemical Formula F-1, “m” is preferably 0 or an integer of from 1 to 10 and “n” is preferably 0 or an integer of from 1 to 40.

CF₃CF₂(CF₂CF₂)ₘ—CH₂CH₂O(CH₂CH₂O)ₙH Chemical Formula F-2

In the compound represented by the Chemical Formula F-2, Y represents H or CₘF₂ₘ₊₁, where n represents an integer of from 1 to 6, or CH₂CH(OH)CH₂—CₘF₂ₘ₊₁, where m represents an integer of from 4 to 6, or CₚH₂ₚ₊₁, where p is an integer of from 1 to 19. n represents an integer of from 1 to 6. a represents an integer of from 4 to 14.

The fluorochemical surfactant can be procured.

Specific examples include, but are not limited to, SURFLON S-111, S-112, S-113, S-121, S-131, S-132, S-141, and S-145 (all manufactured by ASAHI GLASS CO., LTD.); FLUORAD FC-93, FC-95, FC-98, FC-129, FC-135, FC-170C, FC-430, and FC-431 (all manufactured by SUMITOMO 3M); MEGAFACE F-470, F-1405, and F-474 (all manufactured by DIC CORPORATION); ZONYL TBS, FSP, FSA, FSN-100, FSN, FSO-100, FSO, FS-300, UR, and Capstone™ FS-30, FS-31, FS-3100. FS-34, and FS-35 (all manufactured by The Chemours Company); FT-110, FT-250, FT-251, FT-400S, FT-150, and FT-400SW (all manufactured by NEOS COMPANY LIMITED); POLYFOX PF-136A, PF-156A, PF-151N, PF-154, and PF-159 (manufactured by OMNOVA SOLUTIONS INC.); and UNIDYNE™ DSN-403N (manufactured by DAIKIN INDUSTRIES, Ltd.). Of these, in terms of improvement on print quality, in particular coloring property and permeability, wettability, and uniform dying property on paper, FS-3100, FS-34, and FS-300 of The Chemours Company. FT-110, FT-250, FT-251, FT-400S. FT-150, and FT-400SW of NEOS COMPANY LIMITED, POLYFOX PF-151N of OMNOVA SOLUTIONS INC., and UNIDYNE™ DSN-403N (manufactured by DAIKIN INDUSTRIES, Ltd.) are particularly preferable.

The proportion of the surfactant in the first processing fluid is not particularly limited and it can be suitably selected to suit a particular application. It is preferably from 0.001 to 5 percent by mass and more preferably from 0.05 percent by mass to 5 percent by mass to achieve good wettability and discharging stability.

Other Components

As the other components, known additives can be used, including foam inhibitors or defoaming agents, pH regulators, preservatives and fungicides, and corrosion inhibitors.

Property of First Processing Fluid

Properties of the first processing fluid are not particularly limited and can be suitably selected to suit a particular application. For example, the viscosity, surface tension, and pH are preferable in the following ranges.

The viscosity of the first processing fluid at 25 degrees C. is preferably from 5 to 30 mPa·s and more preferably from 5 to 25 mPa·s to achieve good dischargeability. Viscosity can be measured by equipment such as a rotatory viscometer. RE-80L, manufactured by TOKI SANGYO CO., LTD. The measuring conditions are as follows:
Standard cone rotor (1°34′×R24)
Sample liquid amount: 1.2 mL
Rate of rotation: 50 rotations per minute (rpm)
25 degrees C.
Measuring time: three minutes.

The surface tension of the first processing fluid is preferably 35 mN/m or less and more preferably 32 mN/m or less at 25 degrees C. to level the fluid on the fabric suitably and shorten the drying time of the fluid.

pH of the first processing fluid is preferably from 7 to 12 and more preferably from 8 to 11 to prevent corrosion of metal material in contact with liquid.

Application of Second Processing Fluid

Application of the second processing fluid, hereinafter also referred to as the second application, is to apply the second processing fluid to a fabric.

The sequence of the first and second applications is not particularly limited; it is, however, preferable to use the first processing fluid before the second processing fluid to enhance the dry rubbing fastness of printed matter. The second application can be seamlessly conducted after the first application without any other processes between the two applications; however, it is possible to dry the first processing fluid applied in the first application between the two.

The second application is not particularly limited and can be suitably selected to suit a particular application. It includes inkjetting, blade coating, gravure coating, bar coating, roll coating, dip coating, curtain coating, slide coating, die coating, and spray coating. Of these, inkjetting the fluid to a fabric is preferable. Since the second processing fluid for use in the print method of the present disclosure is stable about the viscosity as described later, meaning having good storage stability, it is suitable for inkjetting, whose discharging ability is strongly affected by the density.

Second Processing Fluid

The second processing fluid contains water and a flocculant. The second processing fluid may optionally furthermore contain an organic solvent, a surfactant, and other components. Since the details of types and proportions of water, the organic solvent, and other components in the second processing fluid are the same as those of the first processing fluid, their descriptions are omitted. Since the properties of the second processing fluid are the same as those for the first processing fluid, their descriptions are also omitted.

Flocculant

A flocculant aggregates ink or makes it sticky when brought into contact with the ink. Specifically, it includes a component for aggregating dispersible particles, typically anionic compounds, including a coloring material or resin contained in ink. When ink contacts the flocculant in the second processing fluid that has been applied onto a fabric, it agglomerates or becomes sticky. So the coloring material in the ink stays on the surface of the fabric, which increases the image density of printed matter.

The reason for using the two different types of fluids, the first processing fluid containing a lubricant and the second processing fluid containing a flocculant, in other words, the reason for not using a processing fluid containing both the lubricant and flocculant, is described below.

As described above, since a flocculant aggregates anionic water-dispersible particles such as the coloring material or resin contained in ink, it is preferably a cationic compound. If a flocculant as the cationic compound and a lubricant are present together in a processing fluid, the flocculant aggregates the lubricant, thereby making the processing fluid sticky. It is therefore preferable to contain a lubricant and flocculant in different processing fluids in terms of long-terms storage stability. Since a flocculant, which is cationic, readily aggregates an anionic lubricant, both liquids are preferably stored separately in terms of the storage stability. Therefore, the first processing fluid should contain a lubricant and a negligible flocculant, and the second processing fluid should contain a flocculant and a negligible lubricant. “Negligible” represents none or a tiny amount of a particular component having no impact. For example, a specific component is not detected by a known and familiar technical analysis.

Inkjetting is suitable in the present disclosure because the first processing fluid containing a lubricant and the second processing fluid containing a flocculant are stored and applied separately so that the viscosity of each fluid is stable compared with a processing fluid containing both agents.

Examples of the flocculant include, but are not limited to, an organic salt, inorganic salt, and cationic polymer. An organic or inorganic salt is preferable for safety reason. A monovalent organic or inorganic salt is preferable to enhance the washing fastness of obtained printed matter and a di- or higher valent inorganic salt is preferable to enhance the image density. These can be used alone or in combination.

Specific examples of the inorganic salts include, but are not limited to, mono-valent inorganic salts including sodium chloride, potassium chloride, and potassium nitride, and di- or higher valent inorganic salts including calcium carbonate, calcium nitride, calcium chloride, calcium acetate, calcium sulfate, nickel chloride, barium sulfate, zinc sulfate, zinc carbonate, aluminum silicate, calcium silicate, magnesium silicate, aluminum hydroxide, aluminum sulfate, aluminum phosphate, aluminum lactate, polyaluminum chloride, ferric sulfate, potassium aluminum sulfate, potassium iron alum, and ammonium iron alum.

Specific examples of the organic salts include, but are not limited to, ammonium acetate, ammonium formate, ammonium oxalate, and ammonium lactate.

As the cationic polymer, quaternary ammonium salt type cationic polymers are preferable.

Specific examples include, but are not limited to, polymers of dialkylaryl ammonium chloride, polymers of dialkyl aminoethyl (meth)acrylate quaternary ammonium salts, polymers of modified polyvinyl alcohol dialkyl ammonium salts, and polymers of dialkyl diallyl ammonium salts.

Specific examples of the other cationic polymers include, but are not limited to, cationic specially-modified polyamine compounds, cationic polyamide polyamine compounds, cationic urea-formarine resin compounds, cationic polyacrylic amide compounds, cationic alkyl ketene dimers, cationic dicyane diamide compounds, cationic dicyan diamide-formarine condensation compounds, cationic dicyan diamide-polyamine condensation compounds, cationic polyvinyl formamide compounds, cationic polyvinyl pyridine compounds, cationic polyalkylene polyamine compounds, and cationic epoxy polyamide compounds.

The proportion of a flocculant to the second processing fluid is from 0.1 to 10.0 percent by mass and more preferably from 0.5 to 5.0 percent by mass to enhance the image density and minimize the occurrence of color bleed and beading of printed matter.

Ink Application

In the ink application, ink is applied to the region of fabric where the first processing fluid and the second processing fluid have been applied. That is, ink is applied to the fabric region containing both a lubricant and flocculant.

Specific examples of the method of applying the ink include, but are not limited to, inkjet printing methods, blade coating methods, gravure coating methods, bar coating methods, roll coating methods, dip coating methods, curtain coating methods, slide coating methods, die coating methods, and spray coating methods. Of these, the inkjet printing method is preferable. Of these, inkjetting the fluid to a fabric is preferable.

Ink

The ink contains a pigment, an organic solvent, and a urethane-based resin particle, and other optional components. Since the details including types and proportions of water, the organic solvent, surfactant, and other components in the ink are the same as those of the first processing fluid, their descriptions are omitted. Since the properties of the ink are the same as those for the first processing fluid, their descriptions are also omitted.

At least one of coloring materials and resin is preferably an anionic compound in accordance with the second processing fluid containing a flocculant, which is preferably a cationic compound. If at least one of coloring materials and resin is an anionic compound, the ink agglomerates or becomes sticky when it contacts the component, flocculant, contained in the second processing fluid. The coloring material stays on the surface of a fabric, thereby enhancing the image density.

Coloring Material

The coloring material has no particular limitation and includes materials such as a pigment and a dye. The former is preferable to the latter. As described above, the coloring material is preferably an anionic substance in terms of a combinational use with a flocculant. Anionic pigments are preferable.

Examples of the pigments include, but are not limited to, black pigments, yellow pigments, magenta pigments, cyan pigments, white pigments, green pigments, orange pigments, and gloss or metallic pigments of gold, silver, and others.

Carbon black manufactured by known methods such as contact methods, furnace methods, and thermal methods can be used as the inorganic pigment in addition to titanium oxide, iron oxide, calcium carbonate, barium sulfate, aluminum hydroxide, barium yellow, cadmium red, and chrome yellow.

Specific examples of organic pigments include, but are not limited to, azo pigments, polycyclic pigments (e.g., phthalocyanine pigments, perylene pigments, perinone pigments, anthraquinone pigments, quinacridone pigments, dioxazine pigments, indigo pigments, thioindigo pigments, isoindolinone pigments, and quinophthalone pigments), dye chelates (e.g., basic dye type chelates and acid dye type chelates), nitro pigments, nitroso pigments, and aniline black. Of these pigments, pigments having good affinity with solvents are preferable. Hollow resin particles and hollow inorganic particles can also be used.

Specific examples of the pigments for black include, but are not limited to, carbon black (C.I. Pigment Black 7) such as furnace black, lamp black, acetylene black, and channel black, metals such as copper, iron (C.I. Pigment Black 11), and titanium oxide, and organic pigments such as aniline black (C.I. Pigment Black 1).

Specific examples of the pigments for color include, but are not limited to: C.I. Pigment Yellow 1, 3, 12, 13, 14, 17, 24, 34, 35, 37, 42 (yellow iron oxide), 53, 55, 74, 81, 83, 95, 97, 98, 100, 101, 104, 108, 109, 110, 117, 120, 138, 150, 153, 155, 180, 185, and 213; C.I. Pigment Orange 5, 13, 16, 17, 36, 43, and 51; C.I. Pigment Red 1, 2, 3, 5, 17, 22, 23, 31, 38, 48:2, 48:2 {Permanent Red 2B(Ca)}, 48:3, 48:4, 49:1, 52:2, 53:1, 57:1 (Brilliant Carmine 6B), 60:1, 63:1, 63:2, 64:1, 81, 83, 88, 101 (rouge), 104, 105, 106, 108 (Cadmium Red), 112, 114, 122 (Quinacridone Magenta), 123, 146, 149, 166, 168, 170, 172, 177, 178, 179, 184, 185, 190, 193, 202, 207, 208, 209, 213, 219, 224, 254, and 264; C.I. Pigment Violet 1 (Rhodamine Lake), 3, 5:1, 16, 19, 23, and 38; C.I. Pigment Blue 1, 2, 15 (Phthalocyanine Blue), 15:1, 15:2, 15:3, 15:4, (Phthalocyanine Blue), 16, 17:1, 56, 60, and 63, C.I. Pigment Green 1, 4, 7, 8, 10, 17, 18, and 36.

The dye is not particularly limited and includes, for example, acidic dyes, direct dyes, reactive dyes, basic dyes. These can be used alone or in combination.

Specific examples of the dye include, but are not limited to, C.I. Acid Yellow 17, 23, 42, 44, 79, and 142, C.I. Acid Red 52, 80, 82, 249, 254, and 289, C.I. Acid Blue 9, 45, and 249, C.I. Acid Black 1, 2, 24, and 94, C.I. Food Black 1 and 2, C.I. Direct Yellow 1, 12, 24, 33, 50, 55, 58, 86, 132, 142, 144, and 173. C.I. Direct Red 1, 4, 9, 80, 81, 225, and 227, C.I. Direct Blue 1, 2, 15, 71, 86, 87, 98, 165, 199, and 202, C.I. Direct Black 19, 38, 51, 71, 154, 168, 171, and 195, C.I. Reactive Red 14, 32, 55, 79, and 249, and C.I. Reactive Black 3, 4, and 35.

The proportion of the coloring material to the ink is preferably from 0.1 to 15.0 percent by mass and more preferably from 1.0 to 10.0 percent by mass in solid content to suit to a particular application of ink.

Pigment ink dispersion is obtained by, for example, preparing a self-dispersible pigment by introducing a hydrophilic functional group into a pigment, coating the surface of a pigment with a resin followed by dispersion, or using a dispersant for dispersing a pigment.

One way of preparing a self-dispersible pigment by introducing a hydrophilic functional group into a pigment is to add a functional group such as a sulfone group and carboxyl group to a pigment (e.g., carbon) to disperse the pigment in water.

One way of dispersing a pigment by coating the surface of the pigment with resin is to encapsulate pigment particles in microcapsules for dispersion in water. This microcapsulated pigment is also referred to as a resin-coated pigment. In this case, all the pigments added are not necessarily entirely coated with a resin. The pigments may contain never or partially coated with a resin.

As the dispersant for use in the dispersion method described above, a known dispersant of a small or large molecular weight, typically a surfactant, is suitable. It is possible to select an anionic surfactant, a cationic surfactant, a nonionic surfactant, an amphoteric surfactant, or others depending on a pigment. Also, a nonionic surfactant, RT-100, manufactured by TAKEMOTO OIL & FAT CO., LTD, and a formalin condensate of naphthalene sodium sulfonate are suitable as the dispersant. Those can be used alone or in combination.

Resin

The resin has no particular limit and can be suitably selected to suit to a particular application. Examples include, but are not limited to, urethane resins, polyester resins, acrylic-based resins, vinyl acetate-based resins, styrene-based resins, butadiene-based resins, styrene-butadiene-based resins, vinylchloride-based resins, acrylic styrene-based resins, and acrylic silicone-based resins. Of these, urethane resins are preferable to enhance the image fastness and flexibility. In addition, anionic resins are preferable in terms of a combinational use with a flocculant as described above.

The form of a resin in ink is not particularly limited. It is preferably a particulate resin. It is possible to mix a resin emulsion in which such resin particles are dispersed in water as a dispersion medium with materials such as a coloring material and an organic solvent to obtain an ink. Particulate resin can be synthesized or procured.

The volume average particle diameter (mean volume diameter) of the resin particle is not particularly limited and can be suitably selected to suit to a particular application. The mean volume diameter is preferably from 10 to 1,000 nm, more preferably from 10 to 200 nm, and particularly preferably from 10 to 100 nm to achieve good fixability and image fastness.

The mean volume diameter can be measured by using an instrument such as a particle size analyzer (Nanotrac Wave-UT151, manufactured by MicrotracBEL Corp.).

The proportion of the resin is not particularly limited and can be suitably selected to suit to a particular application. It is preferably from 1.0 to 30.0 percent by mass and more preferably from 5.0 to 20.0 percent by mass to the mass of ink to secure fixability and storage stability of the ink.

Fabric

A fabric is a subject to which the first processing fluid, the second processing fluid, and the ink have been applied to form printed matter. “Fabric” in the present disclosure means a substance like textile, knitted work, and non-woven fabric, manufactured from fiber. The fiber is preferably organic fiber including synthetic fiber, semi-synthetic fiber, regenerated fiber, and natural fiber.

Specific examples of synthetic fiber include, but are not limited to, polyester, polyamide, acrylic, polyolefin, polyvinyl alcohol, polyvinyl chloride, polyurethane, and polyimide. Specific examples of semi-synthetic fiber include, but are not limited to, acetate, diaceate, and triacetate.

Specific examples of regenerated fiber include, but are not limited to, polynosic, rayon, lyocell, and cupra. Specific examples of natural fiber include, but are not limited to, cotton, hemp, silk, and wool.

Biodegradable polyester compositions can be also used. Biodegradable polyester compositions contain a substance such as biodegradable aliphatic-aromatic polyester or polylactic acid and an optional substance including an organic or inorganic filler.

Specific examples of biodegradable aliphatic-aromatic polyester include, but are not limited to, polybutylene adipate terephthalate (PBAT), polybutylene succinate terephthalate (PBST), and polybutylene sebacate terephthalate (PBSeT). Organic filler includes natural starch, plasticized starch, modified starch, natural fiber, and wood flower. Inorganic filler includes talc flour, montmorillonite, kaolin, chalk, calcium carbonate, graphite, plaster, conductive carbon black, calcium chloride, iron oxide, dolomite, silica, walloasonite, titanium dioxide, silicate, mica, glass fiber, and mineral fiber.

Unlike paper or film, the printed matter formed of a fabric is required to have excellent dry rubbing fastness, washing fastness, and flexibility. Therefore, the first processing fluid containing a lubricant is preferable to achieve these properties.

Since ink readily permeates a fabric compared to paper and film, the coloring material stays little on the surface of the fabric, making it challenging to produce printed matter with a high image density. Therefore, it is preferable to enhance the image density using the second processing fluid containing a flocculant.

Print Device

A print device includes a first container containing the first processing fluid, a second container containing a second processing fluid, an ink container containing ink, a first applying device for applying the first processing fluid to a fabric, a second applying device for applying the second processing fluid to the fabric, and an ink applying device for applying the ink to the fabric region where the first processing fluid and the second processing fluid have been applied, and other optional configurations. One of the other optional configurations is a heating device for heating the liquid applied to a fabric, including the first processing fluid, the second processing fluid, and the ink.

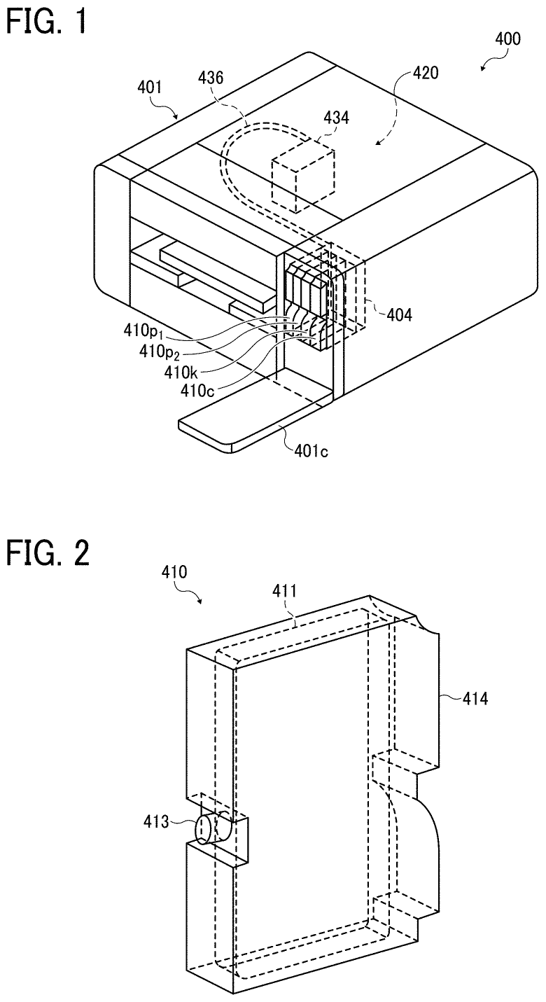

The print device is described with reference to FIG. 1 and FIG. 2. FIG. 1 is a schematic diagram illustrating an example of the print device. FIG. 2 is a schematic diagram illustrating an example of a container for the first processing fluid, second processing fluid, or ink.

A print device 400 illustrated in FIG. 1 includes an inkjet print device having a serial inkjet head. The print device 400 includes a mechanical unit 420 inside an exterior 401.

An accommodating unit 411 of a first processing fluid container 410p₁ for the first processing fluid, the second processing fluid container 410p₂ for the second processing fluid, a black ink container 410k for black ink, and a cyan ink container 410c for cyan ink is formed of a packaging material such as aluminum laminate film. The accommodating unit 411 is housed in a unit such as a plastic container housing unit 414. Each container 410 is used in a form of cartridge.

A cartridge holder 404 is disposed on the rear side of the opening appearing when a cover 401c is opened. Each container 410 is detachably attached to the cartridge holder 404. In this configuration, an exit 413 of each container 410 communicates with an inkjet discharging head 434 via each supply tube 436, an example of the first processing fluid device, the second processing fluid device, and the ink applying device. So the inkjet discharging head 434 can discharge the first processing fluid, second processing fluid, and ink to a fabric.

The print device 400 may optionally include a heating device for heating liquid applied to the fabric including the first processing fluid, the second processing fluid, and the ink. The heating device includes a roll heater, drum heater, heated wind generator, and heat pressing device.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, the present disclosure is described in detail with reference to Examples but is not limited thereto. Unless otherwise specified, the liquids were prepared and evaluated under the conditions of room temperature of 25 degrees C. and humidity of 60 percent.

### Preparation of Processing Liquid

The processing fluid having the prescription shown in Table 1 was prepared according to a known method followed by filtering with a membrane filter, cellulose acetate film, having an average pore diameter of 1.2 μm, to obtain processing fluids 1A to 1I as the first processing fluid, processing fluids 2A to 2C as the second processing fluid, and other processing fluids 3A to 3C other than the first processing fluids and second processing fluids. The amounts of the compositions in Table 1 are represented in percent by mass.

The details of each material shown in Table 1 below are as follows.

Lubricant
KM-862T, nonionic dimethyl polysiloxane having a dispersion particle diameter of 250 nm, manufactured by Shin-Etsu Chemical Co., Ltd.
KM-9782, anionic/nonionic dimethyl polysiloxane having a dispersion particle diameter of 200 nm, manufactured by Shin-Etsu Chemical Co., Ltd.
MEM-1997, cationic dimethyl polysiloxane having a dispersion particle diameter of 150 nm, manufactured by Dow Toray Co., Ltd.
POLON-MF-51, nonionic amino-modified polysiloxane having a dispersion particle diameter of 30 nm, manufactured by Shin-Etsu Chemical Co., Ltd.
X-51-1264, nonionic epoxy-modified polysiloxane having a dispersion particle diameter of 130 nm, manufactured by Shin-Etsu Chemical Co., Ltd.
AQUACER 513, nonionic polyethylene wax having a dispersion particle diameter of 150 nm, manufactured by Mitsui Chemicals, Inc.

Organic Solvent
SOLFIT MMB, 3-methoxy-3-methyl-1-butanol, manufactured by KURARAY CO., LTD.

Surfactant
SAG-503A, silicone-based surfactant, manufactured by Nissin Chemical co., ltd.
BYK-348, silicone-based surfactant, manufactured by BYK Japan KK

Defoaming Agent
AD01, EnviroGem AD01, manufactured by Air Products & Chemicals Inc.

Preservatives and Fungicides
PROXEL LV, manufactured by AVECIA GROUP

TABLE 1

| | | Processing fluid | | | | | Processing fluid | | | |
|---|---|---|---|---|---|---|---|---|---|---|
| | | First processing fluid | | | | | First processing fluid | | | |
| | | 1A | 1B | 1C | 1D | 1E | 1F | 1G | 1H | 1I |
| Lubricant | KM-862T | 1.0 | | | | | | | | |
| | KM-9782 | | | | | | 0.08 | 1.0 | 8.0 | 11.0 |
| | MEM-1997 | | | | | 1.0 | | | | |
| | POLON-MF-51 | | 1.0 | | | | | | | |
| | X-51-1264 | | | 1.0 | | | | | | |
| | AQUACER513 | | | | 1.0 | | | | | |
| Flocculant | Ammonium lactate | | | | | | | | | |
| | Sodium chloride | | | | | | | | | |
| | Calcium nitrate | | | | | | | | | |
| | tetrahydrate | | | | | | | | | |
| Organic | Propylene glycol | 10.0 | 10.0 | 10.0 | 10.0 | 10.0 | 15.0 | 15.0 | 15.0 | 15.0 |
| solvent | SOLFIT MMB | 10.0 | 10.0 | 10.0 | 10.0 | 10.0 | 10.0 | 10.0 | 10.0 | 10.0 |
| Surfactant | SAG-503A | 0.1 | | | | | 0.1 | 0.1 | 0.1 | 0.1 |
| | BYK-348 | | 0.1 | 0.1 | 0.1 | 0.1 | | | | |
| Defoaming | AD01 | 0.5 | 0.5 | 0.5 | 0.5 | 0.5 | 0.5 | 0.5 | 0.5 | 0.5 |
| agent | | | | | | | | | | |
| Preservatives | PROXEL LV | 0.05 | 0.05 | 0.05 | 0.05 | 0.05 | 0.05 | 0.05 | 0.05 | 0.05 |
| and | | | | | | | | | | |
| fungicides | | | | | | | | | | |

| Water | 78.35 | 78.35 | 78.35 | 78.35 | 78.35 | 74.27 | 73.35 | 66.35 | 63.35 |
|---|---|---|---|---|---|---|---|---|---|
| Total | 100 | 100 | 100 | 100 | 100 | 100 | 100 | 100 | 100 |
| | | | | | Processing fluid | | | | |
| | | | | | Second processing | | | | |
| | | | | | fluid | | | Other | |
| | | | | | 2A | 2B | 2C | 3A | 3B |
| | | Lubricant | KM-862T | | | | | | |
| | | | KM-9782 | | | | | | |
| | | | MEM-1997 | | | | | | |
| | | | POLON-MF-51 | | | | | 1.0 | |
| | | | X-51-1264 | | | | | | 1.0 |
| | | | AQUACER513 | | | | | | |
| | | Flocculant | Ammonium lactate | | 2.0 | | | | |
| | | | Sodium chloride | | | 2.0 | | | |
| | | | Calcium nitrate | | | | 1.0 | 1.0 | 1.0 |
| | | | tetrahydrate | | | | | | |
| | | Organic | Propylene glycol | | 15.0 | 15.0 | 10.0 | 10.0 | 10.0 |
| | | solvent | SOLFIT MMB | | 10.0 | 10.0 | 10.0 | 10.0 | 10.0 |
| | | Surfactant | SAG-503A | | | | 0.1 | | 0.1 |
| | | | BYK-348 | | 0.1 | 0.1 | | 0.1 | |
| | | Defoaming | AD01 | | 0.5 | 0.5 | 0.5 | 0.5 | 0.5 |
| | | agent | | | | | | | |
| | | Preservatives | PROXEL LV | | 0.05 | 0.05 | 0.05 | 0.05 | 0.05 |
| | | and | | | | | | | |
| | | fungicides | | | | | | | |

| | | | | | |
|---|---|---|---|---|---|
| Water | 72.35 | 72.35 | 78.35 | 77.35 | 77.35 |
| Total | 100 | 100 | 100 | 100 | 100 |

### Preparation of Ink

### Preparation of Liquid Dispersion of Pigment

After the following recipe was pre-mixed, the mixture was subjected to circulation dispersion for seven hours with a disk type bead mill, KDL type, media: zirconia ball having a diameter of 0.3 mm, manufactured by SHINMARU ENTERPRISES CORPORATION, to obtain a liquid dispersion of pigment with a pigment concentration of 15 percent by mass.
Carbon black pigment, Monarch 800, manufactured by Cabot Corporation: 15.0 percent by mass
Anionic surfactant, A-51-B, manufactured by TAKEMOTO OIL & FAT CO., LTD.: 3.0 percent by mass⋅Water: Balance to make the entire 100 percent by mass

### Preparation of Liquid Dispersion of Resin

In a nitrogen-substituted container equipped with a thermometer, a nitrogen gas-introducing tube, and a stirrer, 200.4 g of polyester polyol, PTMG 1,000, average molecular weight of 1,000, manufactured by Mitsubishi Chemical Corp., 15.7 g of 2,2-dimethylol propionic acid, 48.0 g of isophorone diisocyanate, and 77.1 g of methyl ethyl ketone as an organic solvent were allowed to react using 0.06 g of dibutyltin dilaurate. DMTDL, manufactured by Tokyo Chemical Industry Co., Ltd. as a catalyst. Four hours later, 30.7 g of methylethyl ketone was supplied as a diluting agent to continue the reaction. After continuing the reaction for 6 hours in total, 1.4 g of methanol was added to complete the reaction, thereby obtaining an organic solvent solution of urethane resin. To the organic solvent solution, 13.4 g of a 48 percent by mass aqueous solution of potassium hydroxide was added to neutralize the carboxyl group the urethane resin had. Next, 715.3 g of water was added and adequately stirred, followed by aging and removal of the solvent to obtain a polyester urethane resin liquid dispersion containing resin particles having a solid content concentration of 30 percent by mass.

### Preparation of Ink

The ink having the following composition was prepared according to a common method followed by filtering with a membrane filter, cellulose acetate film, having an average pore diameter of 1.2 μm.
Glycerin: 20.0 percent by mass
SOLFIT MMB: 10.0 percent by mass
SAG-503A: 0.5 percent by mass
AD01: 0.1 percent by mass
PROXEL LV: 0.5 percent by mass
Pigment liquid dispersion: 30.0 percent by mass
Resin liquid dispersion: 30.0 percent by mass
Deionized water: Balance to make the entire 100 percent

### Preparation of Printed Matter

### Example 1

An inkjet printer, Ri100, manufactured by Ricoh Co., Ltd., filled with the processing fluid 1A discharged the 1A to cotton broad cut into A4 size, manufactured by Shikisensha Co., Ltd. with the 1A attached in an amount of 2.0 g/m².

Next, another inkjet printer, Ri100, manufactured by Ricoh Co., Ltd., was filled with the processing fluid 2A and discharged the 2A to the cotton broad to which the 1A was applied with the 2A attached in an amount of 2.0 g/m².

Then, an inkjet printer, Ri6000, manufactured by Ricoh Co., Ltd., was filled with the ink and inkjetted and attached the ink in an amount of 20 g/m² to the cotton broad region to which the 1A and 2A were applied, to form a solid image.

Thereafter, the solid image was dried at 180 degrees C. for 6 minutes in a heated wind circulating thermostatic chamber to prepare printed matter of Example 1.

### Examples 2 to 9

Printed matter of Examples 2 to 9 was obtained in the same manner as in Example 1 except that the processing fluid was changed to those shown in Table 2 below.

### Example 10

An automatic spraying device was filled with the processing fluid 1G′ and discharged and attached the 1G′ in an amount of 10 g/m² to cotton broad cut into A4 size, manufactured by Shikisensha Co., Ltd.

Next, the spraying device was filled with the processing fluid 2C′ and discharged and attached the 2C′ in an amount of 10 g/m² to the cotton broad to which the 1G′ was applied.

Next, the cotton was dried by a heat press at 150 degrees C.

Then, an inkjet printer, Ri6000, manufactured by Ricoh Co., Ltd., was filled with the ink and discharged and attached the ink in an amount of 20 g/m² to the cotton region to which the 1G′ and 2C′ were applied, to form a solid image.

Thereafter, the solid image was dried at 180 degrees C. for 6 minutes in a heated wind circulating thermostatic chamber to prepare printed matter of Example 10.

The processing fluid 1G′ was obtained by diluting the processing fluid 1G by a factor of 5 with water. The processing fluid 2C′ was obtained by diluting the processing fluid 2C by a factor of 5 with water.

### Example 11

Printed matter of Example 11 was obtained in the same manner as in Example 1 except that the sequence of applying the processing fluids 1A and 2A was reversed.

### Example 12

Printed matter of Example 12 was obtained in the same manner as in Example 6 except that the fabric used in Example 6 was changed from the cotton broad to the fabric formed of biodegradable polyester fiber containing the homogeneous mixture containing the compositions below.

Composition of Biodegradable Polyester Fiber
Polybutylene adipate terephthalate: 84.1 parts by mass
Polylactate: 10.0 parts by mass
Talc powder: 1.6 parts by mass
ADR4370, manufactured by BASF SE: 0.3 part
Stearamide: 0.5 parts
Tetrahydrofuran: 15 ppm to the entire composition
Cyclopentanone: 10 ppm to the entire composition

### Comparative Example 1

An inkjet printer, Ri100, manufactured by Ricoh Co., Ltd., filled with the processing fluid 2B discharged and attached the 2B in an amount of 2.0 g/m² to cotton broad cut into A4 size, manufactured by Shikisensha Co., Ltd.

Then, an inkjet printer Ri6000, manufactured by Ricoh Co., Ltd., was filled with the ink and inkjetted and attached the ink in an amount of 20 g/m² to the cotton broad region to which the 2B was applied, to form a solid image.

Thereafter, the solid image was dried at 180 degrees C. for 6 minutes in a heated wind circulating thermostatic chamber to prepare printed matter of Comparative Example 1.

### Comparative Examples 2 and 3

Printed matter of Examples 2 and 3 were obtained in the same manner as in Comparative Example 1 except that the processing fluid was changed to those shown in Table 2 below.

TABLE 2

| | Processing fluid | | | | |
|---|---|---|---|---|---|
| | First | Second | | Sequence | |
| | processing | processing | | of | Application |
| | fluid | fluid | Other | application | method |
| Example 1 | 1A | 2A | | First to | Inkjet |
| | | | | Second | |
| Example 2 | 1B | 2B | | First to | Inkjet |
| | | | | Second | |
| Example 3 | 1C | 2C | | First to | Inkjet |
| | | | | Second | |
| Example 4 | 1D | 2C | | First to | Inkjet |
| | | | | Second | |
| Example 5 | 1E | 2C | | First to | Inkjet |
| | | | | Second | |
| Example 6 | 1F | 2C | | First to | Inkjet |
| | | | | Second | |
| Example 7 | 1G | 2C | | First to | Inkjet |
| | | | | Second | |
| Example 8 | 1H | 2C | | First to | Inkjet |
| | | | | Second | |
| Example 9 | 1I | 2C | | First to | Inkjet |
| | | | | Second | |
| Example 10 | 1G′ | 2C’ | | First to | Spraying |
| | | | | Second | |
| Example 11 | 1A | 2A | | Second to | Inkjet |
| | | | | first | |
| Example 12 | 1F | 2C | | First to | Inkjet |
| | | | | Second | |
| Comparative | | 2B | | Second | Inkjet |
| Example 1 | | | | | |
| Comparative | | | 3A | Other | Inkjet |
| Example 2 | | | | | |
| Comparative | | | 3B | Other | Inkjet |
| Example 3 | | | | | |

The storage stability of the processing fluids used in Examples and Comparative Examples and the image density, dry rubbing fastness, washing fastness, and flexibility of the printed matter obtained in Examples and Comparative Examples were evaluated in the following manner. The evaluation results are shown in Table 3.

Storage Stability

Each processing fluid used in Examples and Comparative Examples were placed in a sealed container. The container was allowed to rest in a thermostatic chamber at 70 degrees C. for two weeks. The viscosity before and after the resting was measured to obtain the change ratio. The storage stability was evaluated using the ratio according to the following criteria. The viscosity was measured with a cone plate rotary viscometer, VISCOMETER TV-22, manufactured by TOKI SANGYO CO., LTD, at a rate of rotation of 50 rpm, a temperature of hemathermal circulating water at 25 degrees C. and a shearing speed of 191.4 sec⁻¹.

Evaluation Criteria
A: Change ratio of viscosity from −5 percent to 5 percent
B: Change ratio of viscosity from −10 percent to less than −5 percent and greater than 5 to 10 percent
C: Change ratio of viscosity of less than −10 percent and greater than 10 percent

After the storage stability test, the inkjet printer Ri100, manufactured by Ricoh Co., Ltd., was filled with the processing fluid followed by discharging the fluid. Some of the nozzles were subject to curved discharging for the processing fluids of Comparative Examples 2 and 3.

Image Density

The image density of the printed matter prepared in each of Examples and Comparative Examples was measured using a spectrophotometer. X-Rite eXact, and evaluated according to the following evaluation criteria.

Evaluation Criteria
A+: Black image density was 1.30 or greater
A: Black image density was from 1.25 to less than 1.30
B: Black image density was from 1.20 to less than 1.25
C: Black image density was less than 1.20

Dry Rubbing Fastness

The printed matter prepared in each of Examples and Comparative Examples was subjected to the dry rubbing fastness test according to JIS L0849 II type format and evaluated according to the following evaluation criteria.

Evaluation Criteria
A+: Grade 4.5 or higher
A: Grade 4.0
B: Grade 3.5
C: Grade 3.0 or lower

Fastness against Washing

The printed matter prepared in each of Examples and Comparative Examples was subjected to the fastness against washing test on discoloration according to JIS L0844 A-2 type format and evaluated according to the following evaluation criteria.

Evaluation Criteria
A+: Grade 4.5 or higher
A: Grade 4.0
B: Grade 3.5
C: Grade 3.0 or lower

Flexibility

The printed matter prepared in each of Examples and Comparative Examples was subjected to the flexibility test on bending resistance according to JIS L1069 E method format and evaluated according to the following evaluation criteria.

Evaluation Criteria
A+: less than 21 g
A: 21 to less than 28 g
B: 28 to less than 35 g
C: 35 g or greater

TABLE 3

| | Processing fluid Storage stability | | | Printed matter | | | |
|---|---|---|---|---|---|---|---|
| | First | Second | | | fastness | fastness | |
| | processing | processing | | Image | against | against | |
| | fluid | fluid | Other | Density | rubbing | washing | Flexibility |
| Example 1 | A | A | | B | A+ | A+ | A+ |
| Example 2 | A | A | | B | A+ | A+ | A+ |
| Example 3 | A | A | | A | A | B | A+ |
| Example 4 | A | A | | A | B | A | B |
| Example 5 | A | A | | A | A | A | A+ |
| Example 6 | A | A | | A | A | A+ | B |
| Example 7 | A | A | | A+ | A+ | A+ | A+ |
| Example 8 | A | A | | A+ | A+ | A | A+ |
| Example 9 | A | A | | A+ | A+ | B | A+ |
| Example 10 | A | A | | A+ | A+ | A+ | A+ |
| Example 11 | A | A | | B | A | A+ | A+ |
| Example 12 | A | A | | A+ | B | A | A+ |
| Comparative | | A | | B | A | A | C |
| Example 1 | | | | | | | |
| Comparative | | | C | A | B | A | B |
| Example 2 | | | | | | | |
| Comparative | | | C | A | A | A | A+ |
| Example 3 | | | | | | | |

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A print method comprising:
applying a first processing fluid comprising water and a lubricant to a fabric;
applying a second processing fluid comprising water and a flocculant to the fabric; and
applying an ink to a region of the fabric where the first processing fluid and the second processing fluid have been applied.

2. The print method according to claim 1,
wherein the applying a first processing fluid includes inkjetting the first processing fluid to the fabric,
wherein the applying a second processing fluid includes inkjetting the second processing fluid to the fabric.

3. The print method according to claim 1,
wherein the flocculant comprises at least one member selected from the group consisting of an inorganic salt, an organic salt, and a cationic polymer

4. The print method according to claim 1,
wherein the lubricant comprises at least one member selected from the group consisting of an anionic compound and a nonionic compound.

5. The print method according to claim 1,
wherein the lubricant comprises a siloxane compound.

6. The print method according to claim 1,
where the lubricant comprises at least one member selected from the group consisting of a dimethyl polysiloxane and an amino-modified organopolysiloxane.

7. The print method according to claim 1,
wherein a proportion of the lubricant to the first processing fluid is from 0.1 to 10.0 percent by mass.

8. The print method according to claim 1,
wherein the first processing fluid further comprises an organic solvent and a silicone-based surfactant,
wherein the second processing fluid further comprises an organic solvent and a silicone-based surfactant.

9. The print method according to claim 1,
wherein the ink comprises a pigment, an organic solvent, and a urethane-based resin particle.

10. A print device comprising:
a first container containing a first processing fluid comprising water and a lubricant;
a second container containing a second processing fluid comprising water and a flocculant
an ink container containing an ink;
a first applying device configured to apply the first processing fluid to a fabric;
a second applying device configured to apply the second processing fluid to the fabric; and
an ink applying device configured to apply the ink to a region of the fabric where the first processing fluid and the second processing fluid have been applied.
